(19) United States
(12) Patent Application Publication
(10) Pub. No.: US 2007/0005257 A1
(43) Pub. Date: Jan. 4, 2007

(54) Bayesian network frameworks for biomedical data mining

(76) Inventors: Jie Cheng, Cranbury, NJ (US); Claus Neubauer, Monmouth Junction, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/110,496

(22) Filed: Jul. 25, 2005

Related U.S. Application Data
(60) Provisional application No. 60/576,043, filed on Jun. 1, 2004.

(51) Int. Cl. G06F 19/00

(52) U.S. Cl. 702/19

(57) ABSTRACT

A system and method for data classification are provided, the system including a processor, an adapter in signal communication with the processor for receiving data, a filtering unit in signal communication with the processor for pre-processing the data and filtering features of the data, a selection unit in signal communication with the processor for learning a Bayesian network (BN) classifier and selecting features responsive to the BN classifier, and an evaluation unit in signal communication with the processor for evaluating a model responsive to the BN classifier; and the method including receiving data, pre-processing the data, filtering features of the data, learning a BN classifier, selecting features responsive to the BN classifier, and evaluating a model responsive to the BN classifier.

### CROSS-REFERENCE TO RELATED APPLICATION

This application claims the benefit of U.S. Provisional Application Ser. No. 60/576,043 (Attorney Docket No. 2004P09220US), filed Jun. 1, 2004 and entitled “A Bayesian Network Framework for Biomedical Data Mining”, which is incorporated herein by reference in its entirety.

### BACKGROUND

Many tasks in bioinformatics are classification tasks. Such classification tasks include, for example, classifying patients having certain cancers into different subtypes based on their gene expression data; cancer early detection using serum proteomic mass spectrum data; predicting the bioactivity of chemical compounds based on their three-dimensional properties, and the like. These datasets usually have the following common characteristics: the dimensions of the feature vector are often from a few thousands to several hundred thousands; the sample sizes are normally from less than one hundred to several hundred; and the data sets are sometimes highly imbalanced such as by having more samples in a particular class than in other classes. These characteristics bring new challenges to the data mining/machine learning community, such as (a) how to build high performance models without overfitting the data; and (b) how to find a small subset of features (biomarkers) that collectively form a good classifier.

Avoiding overfitting is extremely important for biomedical data mining because with thousands of features and a small sample set, it is quite possible that some features are correlated with the class variable simply by chance. Research has developed various methods to filter out irrelevant features. However, even with most irrelevant features filtered out, there may still be hundreds of features left, and further feature reduction is still needed. Cross-validation techniques are often used to control overfitting. However, when not used properly, it is still possible to learn overfitting models and draw over-optimistic conclusions. This can be critical as wrong conclusions can mislead the research directions in medical sciences.

The final feature selection is important because medical researchers are often more interested in models with a small number of biomarkers. “Black box” models with hundreds of features are difficult to understand and validate. A simple model with a small number of features can also help to reduce the risk of overfitting. To achieve the final feature selection, the commonly used approach is to build a wrapper that applies a heuristic search or genetic algorithm to wrap around the core classifier learning algorithm. Unfortunately, such an approach can be very inefficient.

### SUMMARY

These and other drawbacks and disadvantages of the prior art are addressed by an exemplary Bayesian network framework for biomedical data mining.

An exemplary system for data classification includes a processor, an adapter in signal communication with the processor for receiving data, a filtering unit in signal communication with the processor for pre-processing the data and filtering features of the data, a selection unit in signal communication with the processor for learning a Bayesian network (BN) classifier and selecting features responsive to the BN classifier, and an evaluation unit in signal communication with the processor for evaluating a model responsive to the BN classifier

An exemplary method for data classification includes receiving data, pre-processing the data, filtering features of the data, learning a BN classifier, selecting features responsive to the BN classifier, and evaluating a model responsive to the BN classifier.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches Bayesian network frameworks for biomedical data mining in accordance with the following exemplary figures, in which:

FIG. 1 shows a schematic diagram of a system for Bayesian network framework biomedical data mining in accordance with an illustrative embodiment of the present disclosure;

FIG. 2 shows a flow diagram of a method for Bayesian network framework biomedical data mining in accordance with an illustrative embodiment of the present disclosure;

FIG. 3 shows a graphical diagram of exemplary mass spectra in accordance with the method of FIG. 2;

FIG. 4 shows a graphical diagram of an exemplary ROC curve in accordance with the method of FIG. 2; and

FIG. 5 shows a schematic diagram of an exemplary BN classifier in accordance with the method of FIG. 2.

### DETAILED DESCRIPTION OF PREFERRED EMBODIMENTS

The present disclosure provides Bayesian network (BN) based frameworks for high-dimensional data classification in bioinformatics. Exemplary embodiment frameworks have three components, including: 1) Data pre-processing and feature filtering; 2) BN classifier learning with feature selection; 3) model evaluation using ROC curves. The framework is described in detail using an exemplary application serum proteomic mass spectrum (protein expression) data set. Two other exemplary applications in the fields of gene expression analysis and drug discovery (compound high throughput screening) are also presented. The results show that frameworks of the present disclosure are highly robust for biomedical data mining, and that the Markov blanket based feature selection is a fast and effective way to discover the optimal subset of features.

An exemplary Bayesian network (BN) learning based framework has three components including data pre-processing and feature filtering, efficient BN classifier learning with feature selection, and robust performance evaluation using cross-validation and ROC curves. BN models have the advantage of being able to graphically represent the dependencies (correlations) between different features.

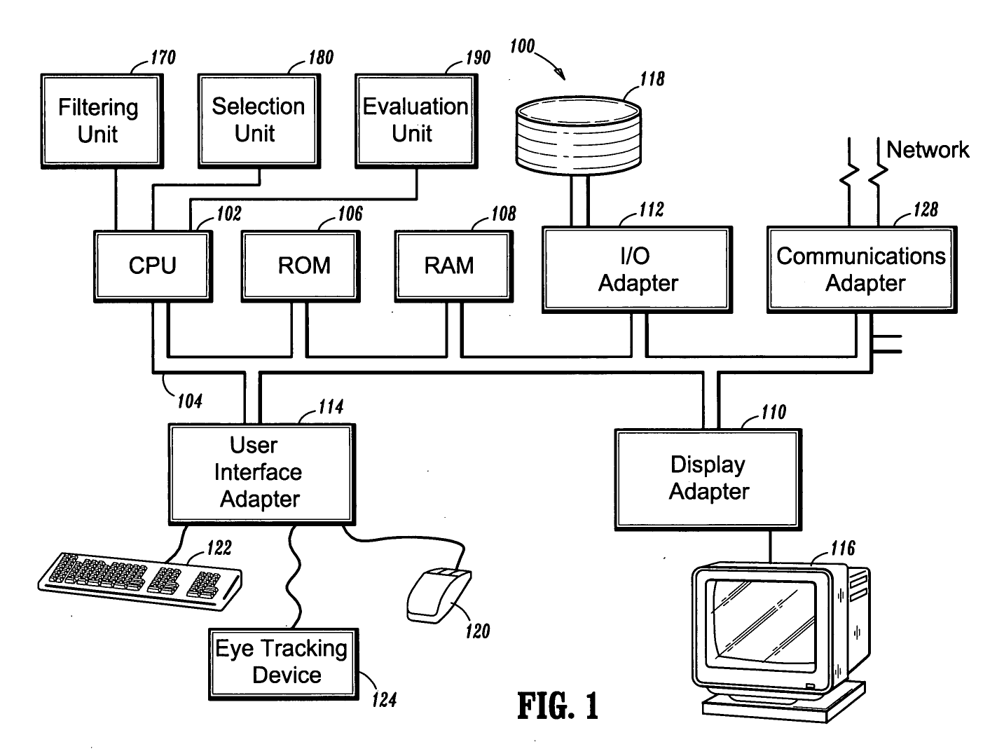

As shown in FIG. 1, a system for illumination invariant change detection, according to an illustrative embodiment of the present disclosure, is indicated generally by the reference numeral 100. The system 100 includes at least one processor or central processing unit (CPU) 102 in signal communication with a system bus 104. A read only memory (ROM) 106, a random access memory (RAM) 108, a display adapter 110, an I/O adapter 112, a user interface adapter 114 and a communications adapter 128 are also in signal communication with the system bus 104. A display unit 116 is in signal communication with the system bus 104 via the display adapter 110. A disk storage unit 118, such as, for example, a magnetic or optical disk storage unit is in signal communication with the system bus 104 via the I/O adapter 112. A mouse 120, a keyboard 122, and an eye tracking device 124 are in signal communication with the system bus 104 via the user interface adapter 114.

A filtering unit 170, a selection unit 180 and an evaluation unit 190 are also included in the system 100 and in signal communication with the CPU 102 and the system bus 104. While the filtering unit 170, selection unit 180 and evaluation unit 190 are illustrated as coupled to the at least one processor or CPU 102, these components are preferably embodied in computer program code stored in at least one of the memories 106, 108 and 118, wherein the computer program code is executed by the CPU 102.

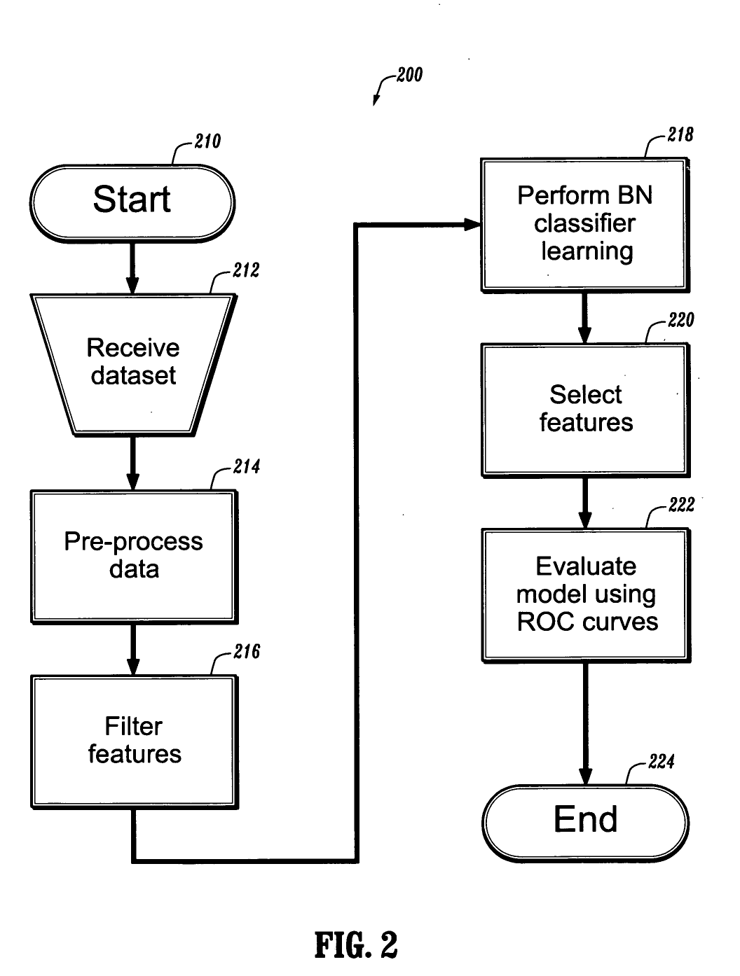

Turning to FIG. 2, an exemplary method for Bayesian network framework biomedical data mining is indicated generally by the reference numeral 200. The method 200 includes a start block 210 that passes control to an input block 212. The input block 212 receives a dataset and passes control to a function block 214. The function block 214, in turn, pre-processes the data and passes control to a function block 216. The function block 216 filters features of the data and passes control to a function block 218.

The function block 218 performs Bayesian network (BN) classifier learning and passes control to a function block 220, which selects features. The function block 220, in turn, passes control to a function block 222, which evaluates the model using ROC curves. The function block 222 passes control to an end block 224.

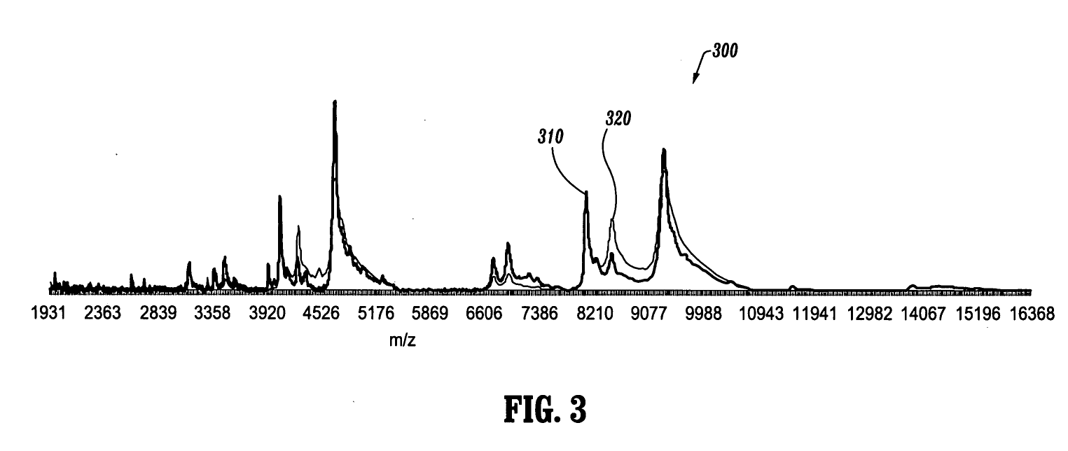

Turning now to FIG. 3, a mass spectra plot is indicated generally by the reference numeral 300. The plot 300 includes a first mass spectra trace 310 and a second mass spectra trace 320, each in the mass range of 1900 to 16500 Da.

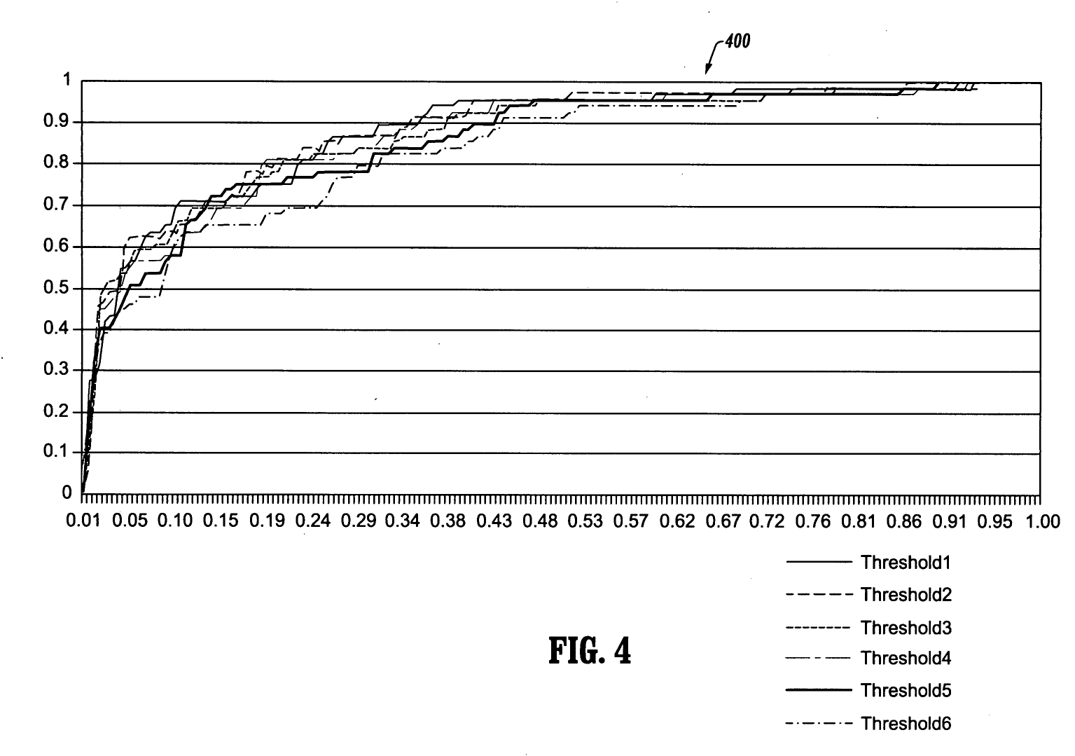

As shown in FIG. 4, an ROC plot is indicated generally by the reference numeral 400. The ROC plot 400 has traces for each of Threshold1 through Threshold6.

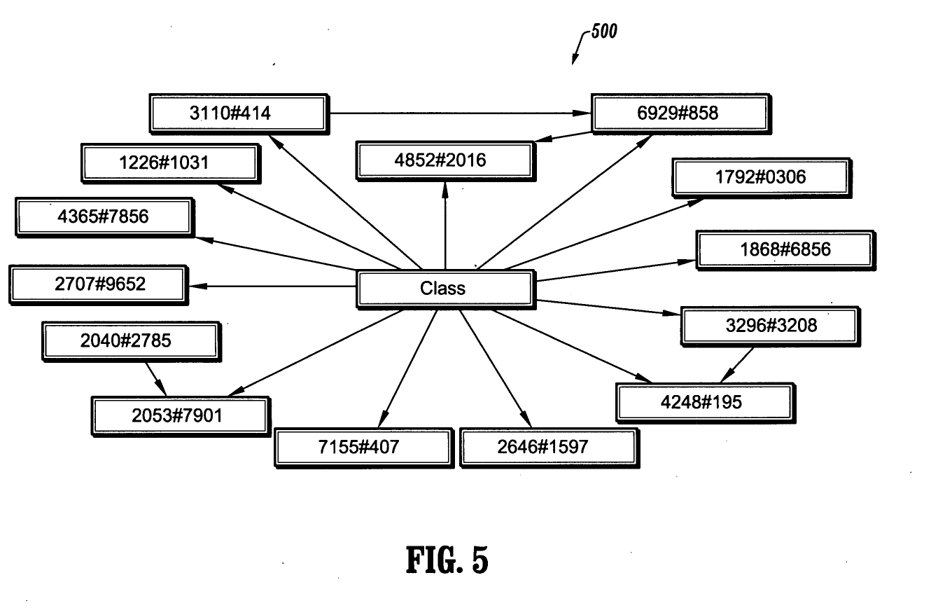

Turning to FIG. 5, an exemplary BN classifier is indicated generally by the reference numeral 500. Here, the feature names are the mass values, such as the x-axis position in a spectrum. The “#” symbol indicates the decimal point.

Bayesian networks and a Bayesian network learning based framework are provided, and a proteomic mass spectrum data set is used to illustrate in detail how an approach operates using the provided framework. In addition, two other bioinformatics application examples are provided in the fields of gene expression analysis and high throughput compound screening.

Bayesian networks are powerful tools for knowledge representation and inference under conditions of uncertainty. A Bayesian network [symbol] is a directed acyclic graph (DAG) [symbol] N,A [symbol] where each node nεN represents a domain variable, and each arc aεA between nodes represents a probabilistic dependency, quantified using a conditional probability distribution (CP table) θᵢεΘ for each node nᵢ. A BN can be used to compute the conditional probability of one node, given values assigned to the other nodes. Hence, a BN can be used as a classifier that gives the posterior probability distribution of the class node given the values of other attributes. A major advantage of BNs over many other types of predictive models, such as neural networks, is that the Bayesian network structure represents the inter-relationships between the dataset attributes. Human experts can easily understand the network structures, and if necessary, modify them to obtain better predictive models.

A Markov boundary of a node y in a BN will be introduced, where y's Markov boundary is a subset of nodes that “shields” y from being affected by any node outside the boundary. One of y's Markov boundaries is its Markov blanket, which is the union of y's parents, y's children, and the parents of y's children. When using a BN classifier on complete data, the Markov blanket of the classification node forms a natural feature subset, as all features outside the Markov blanket can be safely deleted from the BN.

Although the arrows in a Bayesian network are commonly explained as causal links, in classifier learning, the class attribute is normally placed at the root of the structure in order to reduce the total number of parameters in the CP tables. For convenience, one can imagine that the actual class of a sample ‘causes’ the values of other attributes.

The framework of the present disclosure is based on an efficient BN learning algorithm. It has three components including data pre-processing and feature filtering, BN classifier learning, and cross-validation based performance evaluation.

Data pre-processing is extremely domain specific. For example, in mass spectrum protein expression data, the pre-processing normally includes spectrum normalization, smoothing, peak identification, baseline subtraction and the like.

In bioinformatics datasets, there are often thousands of features and the majority of them have no correlation with the target variable at all. When the sample size is small, some irrelevant features may seem to be significant. The goal of feature filtering is to filter out as many irrelevant features as possible, without throwing away useful features. Researchers have applied various parametric and nonparametric statistics to rank the features and select the cutoff point. For example, several nonparametric methods have been studied.

For ease of explanation, exemplary embodiments of the present disclosure use a t-test or mutual information test as set forth in Equation 1 to measure the correlations between each feature and the target variable, and then remove the features that have little or no correlation with the target variable. However, other methods as known in the art may be applied as needed.

$$I ( A , B ) = {\sum }_{a , b} P ( a , b ) log \frac{P ( a , b )}{P ( a ) P ( b )} \qquad ( Equation 1 )$$

A unique BN learning algorithm is provided, based on three-phase dependency analysis, which is especially suitable for data mining in high dimensional data sets due to its efficiency. Here, the complexity is roughly O(N²) where N is the number of features. Following study of learning Bayesian networks as classifiers, the empirical results on a set of standard benchmark datasets show that Bayesian networks are excellent classifiers. In addition, Bayesian network learning system embodiments have been developed for general Bayesian network learning and for classifier learning.

The exemplary BN learning algorithm requires discrete (categorical) data. For numerical features, discretization is performed before model learning. The discretization procedure can be based on domain knowledge or some discretization algorithms. Entropy binning is one of such algorithms that minimize the information loss between the feature and the target variable.

Because the sample sizes of bioinformatics datasets are rarely large enough to set aside a portion of the samples as a test set, embodiments use a standard cross-validation procedure to evaluate model performances in most of the studies. In a k-fold cross-validation procedure, the dataset is partitioned into k disjoint subsets and cross validation is performed k times, each time using a different subset as the validation set and the rest of the k−1 subsets as the training set. The performances of k validation sets are then combined to get the final validation performance. 10-fold cross-validation may normally be performed when the sample sizes are larger than one hundred, and leave one out cross-validation, where the number of folds is equal to the number of samples, may otherwise be performed.

When performing cross-validation, one needs to make sure that the validation set of each iteration is truly independent of the training set. That is, that there is no information leak between the training and validation sets. Information leak will occur when the feature filtering or data discretization is performed on the whole data set, rather than on the training set of each iteration of the cross validation.

An exemplary application in Proteomic Mass Spectrum Analysis is now presented. Proteomic mass spectrum data are acquired from body fluid samples using mass spectrometry techniques. Compared to gene expression analysis, proteomic pattern or protein expression analysis is a relatively new research field in bioinformatics. The idea behind such research is that the proteomic patterns of body fluids like blood serum can reflect the pathologic states of organs and tissues. Proteomic pattern analysis can either be applied directly as a new tool for cancer screening and diagnosis or be used to find the corresponding proteins and develop new assays for cancer diagnosis. Various public and nonpublic proteomic mass spectrum datasets have been analyzed using the exemplary method in several different cancer research projects, and produced encouraging results.

A public dataset for prostate cancer diagnosis is used to show the approach to such tasks. This dataset has been studied before, and contains 190 samples from patients with benign prostate conditions, 63 samples from health people, and 69 patients with prostate cancer. Because the goal of the study is to see whether proteomic patterns can be used as an auxiliary tool to accompany the standard prostate-specific antigen (PSA) test, we omit the 63 healthy samples with PSA<1 and only use the rest of the 259 samples that all have PSA >4.

Referring back to FIG. 3, note that the two mass spectra are in the mass range of 1900 to 16500 Da. The raw dataset contains one spectrum for each sample. There are 15154 data points in each mass spectrum with the mass range (m/z) from 0 to 20,000 Da. In this study, the range from 0 to 1,200 Da at the beginning of each spectrum was ignored because of the high noise level. This leaves 11441 data points for each spectrum.

The height of the same peak in a mass spectrum can vary in different runs using the same sample. To make the spectra comparable, normalization is usually performed. Common methods include the sum of intensity based method and the standard normal variate correction method. Because the mass accuracy is normally 0.1% to 0.3%, there are often too many data points in the mass spectroscopy readout. Smoothing can be performed to lower the resolution and reduce noise. For this data set, the sum of intensity was used to normalize the spectra and the spectra were smoothed by averaging the neighboring 8 data points.

Peak identification is normally required because the peaks in mass spectra represent different peptides/proteins, which can be used as biomarkers for cancer diagnosis. The peaks may be discovered by a simple computer program or by visually examining the spectra, for example. A mass spectrum normally exhibits a base noise level, which varies across the m/z axis. Therefore, a certain kind of local correction is required to remove this base noise, such as a fixed window based method or a local linear regression based method. Here, a fixed window based tool is used to automatically discover peaks and do baseline correction, such as adjusting the peak height, at the same time.

After the preprocessing step, each spectrum contains 1431 data points or features. In each spectrum, if a data point is at the location of a peak, the value of the data point is the adjusted height of the peak. The data points have value zero if they are at the non-peak region. The exemplary embodiment method automatically detected about 9400 peaks in total, about 36.5 peaks per spectrum. Many of the features are in non-peak region across all the spectra. These features are discarded. The dataset, after preprocessing, has about 280 features.

Although a dataset with 280 features is already quite manageable, one may still want to filter out the irrelevant features for efficiency reasons. The entropy binning method may be used to discretize the data and calculate the mutual information, as in Equation 1, between each feature and the target variable. The result shows that only the top 70 features or peaks are correlated to the target variable. In order not to wrongly discard any useful features, 180 features were filtered out.

It shall be understood that the above procedure is used to give an approximation of how many features can be safely filtered out. Because different Bayesian network models are evaluated using cross-validation, the feature filtering and feature discretization need to be performed only on the training set during each iteration of cross validation to avoid information leak.

For BN classifier learning, a BN Power Predictor system is used. This system takes as input the training set with 100 features. The sample size of the training set is 90% of the total 259 cases in 10-fold cross-validation.

Referring back to FIG. 5, the system outputs a Bayesian network that has a structure that shows the dependencies between the target variable and the 100 features, and also shows the dependencies between the 100 features. The system uses the Markov blanket concept to automatically simplify the structure to keep only the features that are on the Markov blanket of the target variable. This feature selection is a natural by-product of the model learning and no wrapper approach is used to get the optimal feature subset. The number of features on the Markov blanket is related to the complexity of the BN model. A more complex BN model with many connections between the nodes or features will be likely to have more features on the Markov blanket The complexity of the learned BN model is controlled by one parameter. The range of the appropriate parameters to use is normally known based on the sample size and the strength of the correlations between the features. A few parameters within the range are often used to find the best one.

A single run of the BN Power Predictor system takes about 30 seconds for such datasets with about 250 cases and 100 features, on an average PC. So the fold cross-validation will take about 5 minutes. The running time is roughly linear to the number of samples and O(N²) to the number of features.

Based on the sample size, 10-fold cross-validation was used. After getting 10 pairs of training and validation sets, feature filtering (selecting top 100 features from 280 features) and feature discretization were performed on each of the training sets. This process takes about 1 minute.

Referring back to FIG. 4, 10-fold cross-validation was performed 6 times, each time using a different threshold to control the model complexity. The different threshold settings are referred to as Threshold1 to Threshold6, with Threshold 1 being the smallest threshold. Using Threshold1, the models in all 10 iterations of the cross validation have about 20 features, on average. The models of Threshold6 have about 10 features, on average. The results of 10 validation sets using each threshold setting are combined into one ROC (??? is this “Region of Convergence” ???) curve. FIG. 4 shows the ROC plots of the different threshold settings. The areas under the ROC (AUROC) for Threshold1 to Threshold6 are 0.88, 0.88, 0.87, 0.87, 0.86, 0.84, which suggests that the models obtained using Threshold6 are probably too simple (i.e., under-fitting).

For sensitivity 0.90, the range of the specificities of the six settings is from 0.69 to 0.56 with mean 0.63. If the required sensitivity is 0.80, the range of the specificities of the six settings is between 0.70 and 0.81. Considering that the traditional prostate-specific antigen (PSA) method has a specificity around 0.25, this is already quite encouraging. Furthermore, the patients currently classified as having benign condition may develop prostate cancer later on, so the actual specificity can be higher. Referring once more back to FIG. 5, the structure of one of the learned BN models is shown.

The exemplary embodiment framework has also been successfully applied to gene expression and drug discovery datasets. The datasets are a well-known Leukemia gene expression dataset and the KDD Cup 2001 drug discovery dataset.

The Leukemia gene expression dataset contains 72 samples of Leukemia patients belonging to two groups: acute myeloid leukemia (AML) and acute lymphoblastic leukemia (ALL). For each patient, gene expression data of about 7000 genes were generated. The dataset has already been preprocessed and absolute calls (to categorize the values into present, marginal or absent) were generated using a predetermined threshold. By calculating the mutual information between each gene and the target variable, it was decided to keep 150 genes and filter out the rest. This procedure needs to be carried out during each iteration of the cross validation. Because of the small sample size, leave one out cross-validation was used. Leave one out cross-validation was run four times using four different thresholds. The BN models generated with the smallest threshold have 12 genes on average, while the models generated with the largest threshold have only 4 genes on average. The number of validation errors for the four thresholds (from small to large) are: 1, 0, 2, 2. The average misclassification rate of the four settings is only 1.7%. The total run time of this experiment is less than 2 hours on an average PC.

The Compound Screening for Drug Discovery dataset was provided for KDD Cup data mining competition. The goal was to predict whether a compound could actively bind to a target site on thrombin. The training set has 1909 compounds, in which only 42 are positive. Each compound is represented by 139,351 binary features. The test set contains 634 unlabelled compounds. After calculating the mutual information between each feature and the target variable, it was found to be safe to keep only the top 100 features. Because of the constraint of time and computing resources at that time, the cross-validation was skipped and several models were learned from the whole dataset using different thresholds, and training errors were produced in terms of AUROC rather than validation errors from cross-validation. The number of features on the Markov blanket of these models is from 2 to 12. To avoid overfitting the data, the simplest model having decent training error was picked, and it only contains four features. This model ranked the highest of over 120 solutions.

When learning predictive models from bioinformatics datasets, effective feature reduction and rigorous model validation are crucial. The BN learning based frameworks of the present disclosure each combines feature filtering and Markov blanket feature selection to discover the biomarkers, and applies cross-validation and AUROC to evaluate different models. Compared to the wrapper approach based biomarker discovery, such as used in the genetic algorithm, the presently disclosed BN Markov blanket based approach is much more efficient in that no search algorithm is needed to wrap around the core model learning algorithm.

It is to be understood that the teachings of the present disclosure may be implemented in various forms of hardware, software, firmware, special purpose processors, or combinations thereof. Most preferably, the teachings of the present disclosure are implemented as a combination of hardware and software.

Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (CPU), a random access memory (RAM), and input/output (I/O) interfaces.

The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. For example, the exemplary method for determining how many features should be filtered out may be augmented or replaced with more sophisticated feature filtering techniques. For another example, the BN learning algorithm framework may be incorporated into advanced medical decision support systems that are based on multi-modal data, such as clinical data, genetic data, proteomic data and imaging data. All such changes and modifications are intended to be included within the scope of the present disclosure as set forth in the appended claims.

What is claimed is:

1. A method for data classification comprising:
receiving data;
pre-processing the data;
filtering features of the data;
learning a Bayesian network (BN) classifier;
selecting features responsive to the BN classifier; and
evaluating a model responsive to the BN classifier.

2. A method as defined in claim 1 wherein selecting features is responsive to a Markov blanket based feature selection for discovering the optimal subset of features.

3. A method as defined in claim 1 wherein evaluating uses cross-validation.

4. A method as defined in claim 1 wherein model graphically represents the dependencies or correlations between different features.

5. A method as defined in claim 1 wherein evaluating uses ROC curves.

6. A method as defined in claim 5 wherein each ROC curve results from the combination of a plurality of validation sets using each of a plurality of threshold settings.

7. A method as defined in claim 1 wherein the data comprises high-dimensional bioinformatics.

8. A method as defined in claim 7 wherein the data comprises at least one of serum proteomic mass spectrum or protein expression data, gene expression data, and drug discovery or compound high-throughput screening data.

9. A system for data classification comprising:
a processor;
an adapter in signal communication with the processor for receiving data;
a filtering unit in signal communication with the processor for pre-processing the data and filtering features of the data;
a selection unit in signal communication with the processor for learning a Bayesian network (BN) classifier and selecting features responsive to the BN classifier; and
an evaluation unit in signal communication with the processor for evaluating a model responsive to the BN classifier.

10. A system as defined in claim 9, the selection unit comprising Markov blanket means for discovering the optimal subset of features.

11. A system as defined in claim 9, the evaluation unit comprising cross-validation means.

12. A system as defined in claim 9, further comprising a second adapter for graphically representing the dependencies or correlations between different features.

13. A system as defined in claim 9 wherein the evaluation unit uses ROC curves.

14. A system as defined in claim 13 wherein each ROC curve results from the combination of a plurality of validation sets using each of a plurality of threshold settings.

15. A system as defined in claim 9 wherein the data comprises high-dimensional bioinformatics.

16. A system as defined in claim 15 wherein the data comprises at least one of serum proteomic mass spectrum or protein expression data, gene expression data, and drug discovery or compound high-throughput screening data.

17. A program storage device readable by machine, tangibly embodying a program of instructions executable by the machine to perform program steps for data classification, the program steps comprising:
receiving data;
pre-processing the data;
filtering features of the data;
learning a Bayesian network (BN) classifier;
selecting features responsive to the BN classifier; and
evaluating a model responsive to the BN classifier.

18. A device as defined in claim 17 wherein the program step for selecting features is responsive to a Markov blanket based feature selection for discovering the optimal subset of features.

19. A device as defined in claim 17 wherein the data comprises high-dimensional bioinformatics.

20. A device as defined in claim 19 wherein the data comprises at least one of serum proteomic mass spectrum or protein expression data, gene expression data, and drug discovery or compound high-throughput screening data.
